(19) United States
(12) Patent Application Publication
(10) Pub. No.: US 2002/0160077 A1
(43) Pub. Date: Oct. 31, 2002

(54) Chewing gum compositions and method of use

(76) Inventor: Michael Gurin, Glenview, IL (US)

Correspondence Address: Michael H. Gurin, 4132 Cove Lane, Unit A, Glenview, IL, 60025, US

(21) Appl. No.: 10/124,131

(22) Filed: Apr. 18, 2002

Related U.S. Application Data
(60) Provisional application No. 60/286,233, filed on Apr. 26, 2001.

(51) Int. Cl. A23G 3/30

(52) U.S. Cl. 426/3

(57) ABSTRACT

A composition and method for supplementing a water soluble gum portion and a water insoluble gum base portion including an enzymatically modified fats, oils, and generally fatty acids of mono-, di-, and tri-glycerides in chewing gum systems. The composition is selected from the group of (A) an enzymatically modified fatty acids of mono-, di-, and tri-glycerides or lipolyzed fatty acids of mono-, di-, and tri-glycerides with, (B) an encapsulating agent, and (C) standard chewing gum additives. The composition provides an effective increase in new flavor profiles, superior mouthfeel, acceptance, nutritional, therapeutic, and pharmacological properties in food, nutrition and diet systems through chewing gum.

### CROSS-REFERENCE TO RELATED APPLICATIONS

This application claims priority from U.S. Provisional Patent Application Serial No. 60/286,233 filed Apr. 26, 2001.

### BACKGROUND OF THE INVENTION

The present invention relates to the field of chewing gum compositions and in particular to compositions that incorporate flavors derived from dairy fats and creams, vegetable oils, nut oils and other fatty acids of mono-, di-, and tri-glycerides for consumer use of chewing gum and to enhance and prolong the flavor release characteristics of chewing gum.

U.S. Pat. No. 5,223,283 discloses the use of between about 0.3 and about 2.4 percent cocoa powder with the specific intent of not contributing a chocolate flavor to the gum base and solely for the purpose of making synthetic gum base taste more like a natural gum base.

U.S. Pat. No. 4,889,726 discloses the use of cocoa powder between about 0.08 and 0.5 percent by weight of the chewing gum as a method of enhancing the flavor of a mint flavored chewing gum, again with the specific intent of not contributing a chocolate flavor to the gum base.

The present invention provides a new, optimal and low cost composition and method of use, which achieves superior performance and new applications over the above-referenced prior art, and others.

### SUMMARY OF THE INVENTION

As used herein, the term “new flavor profiles” refers to a chewing gum composition that incorporates flavors from oils, fats, creams and fatty acids of mono-, di-, and tri-glycerides derived from vegetable oils, nut oils, dairy products, and bean products.

As used herein, the term enzymatically or lipolyzed modified triglycerides, hereinafter referred to as “ELMT”, includes enzymatically modified oils, fats, and fatty acids of mono-, di-, and tri-glycerides, and lipolyzed modified oils, fats, and fatty acids of mono-, di-, and tri-glycerides.

The inventive enzymatically modified oils, fats, and fatty acids of mono-, di-, and tri-glycerides, and lipolyzed modified oils, fats, and fatty acids of mono-, di-, and tri-glycerides may be prepared into chewing gums that mimic the texture and chew properties of conventional chewing gum by employing standard conventional methods for compounding chewing gum as are known in the art. Such conventional methods include the following: adding gum base components selected from the group elastomers; elastomer plasticizers; fillers; softeners; waxes; antioxidants; colorants; emulsifiers; colors; acidulants; texturing agents; and other components that provide desired attributes and adding time release components selected from the group of flavors; flavoring agents; colors; acidulants; minerals, vitamins and bioactive agents.

The inventive enzymatically modified oils, fats, and fatty acids of mono-, di-, and tri-glycerides, and lipolyzed modified oils, fats, and fatty acids of mono-, di-, and tri-glycerides may also include active release agents, including, without limitation, compounds that permit a controlled release of flavor, pharmaceutical, or nutraceutical actives. The process includes the controlled flavor release over an extended duration for either longer lasting flavors and actives or the lower level of expensive flavors and actives.

It is preferable in accordance with another aspect of the present invention to compound the enzymatically modified oils, fats, and fatty acids of mono-, di-, and tri-glycerides, and lipolyzed modified oils, fats, and fatty acids of mono-, di-, and tri-glycerides in accordance with known methods for preparing chewing gum.

In accordance with another aspect of the present invention, the chewing gums derived from enzymatically modified oils, fats, and fatty acids of mono-, di-, and tri-glycerides, and lipolyzed modified oils, fats, and fatty acids of mono-, di-, and tri-glycerides are further prepared into chewing gums utilizing standard principles of making active release chewing gums. As used herein the term “active release” refers to a gum that provides a controlled release of actives selected from the group of flavors, pharmaceutical, and nutraceutical actives.

The inventive enzymatically modified oils, fats, and fatty acids of mono-, di-, and tri-glycerides, and lipolyzed modified oils, fats, and fatty acids of mono-, di-, and tri-glycerides may also include a fruit concentrate sweetener composition.

Advantages of the present invention include providing a chewing gum composition that introduces new flavor profiles and increased intensity of existing flavor profiles while mimicking the texture and chew properties of chewing gum.

Another advantage of the present invention is a controlled flavor release over an extended duration.

Yet another advantage of the present invention is that a lower level of flavor may be used compared to conventional chewing gums.

A still further advantage of the present invention is that enzymatically modified oils, fats, and fatty acids of mono-, di-, and tri-glycerides, and lipolyzed modified oils, fats, and fatty acids of mono-, di-, and tri-glycerides are further solubilized compared to conventional chewing gums.

Yet another advantage of the present invention is the standard texture and mouthfeel associated with non-triglyceride flavorants throughout the chewing experience of chewing gum.

Another advantage of the present invention is to provide flavored granules that can be simply mixed into chewing gum base to provide natural flavor without cholesterol and with very little caloric content.

A still further advantage of the present invention is to provide a method of encapsulating the flavored granules to achieve time release of the flavor.

As used herein, the term “graft copolymers of monomeric and polymeric polyhydroxy compounds” is used within the context of the present invention to include graft copolymers of individual monomeric, individual polymeric polyhydroxy compounds, blends of individual monomeric and polymeric polyhydroxy compounds, blends of multiple monomeric and individual polymeric polyhydroxy compounds, blends of individual monomeric and multiple polymeric polyhydroxy compounds, and blends of multiple monomeric and multiple polymeric polyhydroxy compounds. As used herein the term grafted polyhydroxy copolymers is intended to include all compounds within the above definition and is hereinafter referred to as “GCPH” or “GCPH copolymers”.

The inventive graft copolymers prepared with levels up to 15% on a total weight basis of standard unmodified oils, fats, and triglycerides into chewing gums that mimic the texture and chew properties of conventional chewing gum by employing standard conventional methods for compounding chewing gum as are known in the art. Such conventional methods include the following: adding gum base components selected from the group elastomers; elastomer plasticizers; fillers; softeners; waxes; antioxidants; colorants; emulsifiers; colors; acidulants; texturing agents; and other components that provide desired attributes and adding time release components selected from the group of flavors; flavoring agents; colors; acidulants; minerals, vitamins and bioactive agents.

The inventive graft copolymers prepared with levels up to 15% on a total weight basis of standard unmodified oils, fats, and fatty acids of mono-, di-, and tri-glycerides and also include active release agents, including, without limitation, compounds that permit a controlled release of flavor, pharmaceutical, or nutraceutical actives. The process includes the controlled flavor release over an extended duration for either longer lasting flavors and actives or the lower level of expensive flavors and actives.

The inventive graft copolymers prepared with levels up to 15% on a total weight basis of standard unmodified oils, fats, and fatty acids of mono-, di-, and tri-glycerides are further preferably compounded employing conventional methods for making chewing gums that mimic texture and chew properties of conventional gums without levels limited to 2% on a total weight basis dairy fats and creams, vegetable oils, nut oils or other fatty acids of mono-, di-, and tri-glycerides.

In accordance with another aspect of the present invention, the chewing gums derived from graft copolymers of monomeric and polymeric polyhydroxy compounds and levels up to 15% on a total weight basis of standard unmodified oils, fats, and fatty acids of mono-, di-, and tri-glycerides are further prepared into chewing gums utilizing standard principles of making active release chewing gums. As used herein the term “active release” refers to a gum that provides a controlled release of actives selected from the group of flavors, pharmaceutical, and nutraceutical actives.

Advantages of the present invention include providing a chewing gum composition naturally flavored with dairy fats and creams, vegetable oils, nut oils and other fatty acids of mono-, di-, and tri-glycerides and has acceptable flavor, texture, sweetness and organoleptic qualities.

Additional features and advantages of the present invention are described in and will be apparent from the detailed description of the presently preferred embodiments. It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

### DETAILED DESCRIPTION OF THE PREFERRED EMBODIMENTS

The present invention provides improved chewing gum compositions and methods for making same. Pursuant to the present invention, chewing gum compositions are provided that includes enzymatically modified triglycerides. Fatty acids of mono-, di-, and tri-glycerides are liberated by enzymatic modification and reduction processes or lipolyzed. The resulting products are hereinafter referred to as enzymatically or lipolyzed modified triglycerides (“ELMT”). ELMTs are then subsequently microencapsulated and optionally combined with other ingredients prior to being manufactured into a chewing gum. The importance of ELMTs to chewing gum products are numerous with the primary objective of imparting desirable mouthfeel, enhanced flavor, and providing intensified fatty flavor notes while avoiding the excessive emulsifying affect traditionally associated with triglycerides. The presently preferred embodiments of the invention will now be set forth.

Due to the use of the ELMT, a chewing gum composition is provided that can provide the standard texture and mouthfeel associated with non-triglyceride flavorants throughout the chew. Still further, the ELMT can be encapsulated to enable the time release and delivery of these flavorants to increase the period of consumer satisfaction. To this end flavors, colorants, drugs or nutritional compounds can be attached/encapsulated and then mixed into the gum base to become a chewing gum for the consumer.

As noted, ELMT may be added to typical gum base formulas as supplemental flavors or itself used as the gum flavorant. Additionally, the ingredients of the chewing gum formulations may be modified to provide desirable characteristics.

A composition and method for supplementing a water soluble gum portion and a water insoluble gum base portion including a enzymatically modified fats, oils, and generally triglycerides in chewing gum systems. The composition is selected from the group of (A) an enzymatically modified oils, fats, and fatty acids of mono-, di-, and tri-glycerides, (B) lipolyzed modified oils, fats, and fatty acids of mono-, di-, and tri-glycerides, (C) an encapsulating agent, and (D) standard chewing gum additives. The composition provides an effective increase in new flavor profiles, superior mouthfeel, acceptance, nutritional, therapeutic, and pharmacological properties in food, nutrition and diet systems through chewing gum.

Enzymatically modified fats, oils, and fatty acids of mono-, di-, and tri-glycerides are selected from the group of dairy fats and creams, vegetable oils, nut oils, and other fatty acids of mono-, di-, and tri-glycerides. Preferred fats, oils, and fatty acids of mono-, di-, and tri-glycerides are selected from the group of cocoa butter, nut oils, butter, cheese, milk.

Cocoa butter is processed with lipase enzymes to free the flavorful fatty acids from their triglyceride bond, resulting in a cocoa butter that provides a stronger flavor sensation. Lecithin is added as an emulsifier. Enzymes are then deactivated and encapsulated to make a dry powder.

The present invention does not further preclude the use of enzymatically modified cocoa butter, as above, being combined with additional ingredients prior to encapsulation. Preferred additional ingredients are selected from the group of dry milk powder and chocolate solids.

Butter is processed with lipase enzymes to free the flavorful fatty acids from their triglyceride bond, resulting in a butter that provides a stronger flavor sensation. Enzymes are then deactivated and encapsulated to make a dry powder.

Cheese is processed with lipase enzymes to free the flavorful fatty acids from their triglyceride bond, resulting in a cheese that provides a stronger flavor sensation. Enzymes are then deactivated and encapsulated to make a dry powder.

The present invention does not further preclude the use of enzymatically modified cheese being combined with additional ingredients prior to encapsulation. Preferred additional ingredients are selected from the group of spray dried beer.

Numerous snack foods utilize flavors are selected from the group of hot spices, popcorn, vanilla, cinnamon, fruit, and other known flavors. Natural oils derived from many foods are also processed with lipase enzymes to free the flavorful fatty acids from their triglyceride bond, resulting in a flavor essence that provides a stronger flavor sensation.

Nut oils and meats is processed with lipase enzymes to free the flavorful fatty acids from their triglyceride bond, resulting in a nut flavor that provides a stronger flavor sensation. Preferred nut oils and meats are selected from the group of peanut, almond, pistachio, hazelnut, cashew, walnut, hemp seed and macadamia. Enzymes are then deactivated and encapsulated to make a dry powder.

The present invention does not further preclude the use of enzymatically modified cocoa butter, butter, cream, cheese and all other ELMT flavors being combined with additional ingredients prior to encapsulation. Preferred additional ingredients are selected from the group of dry milk powder, food ingredients, sweeteners, emulsifiers, softeners, colorants, nutraceutical actives, pharmaceutical actives and antioxidants.

The water soluble coating of the spray dried material envelopes the ELMT and thus facilitates distribution thereof in the aqueous phase so that this method of incorporating the flavoring component of the invention results in uniform, stable emulsions which are not readily produced when the ELMTs are used in a liquid form. The water soluble coating or carrier may be a conventional carrier such as non-fat dry milk, starches, corn syrup solids or maltodextrins. Starch hydrolysates having a lower dextrose equivalent are particularly suitable since they are readily water soluble and not too hygroscopic. When the DE is 20 or less, such carriers are referred to as maltodextrins.

The modified triglycerides or oils include natural dairy, chocolate, nut, corn, and oil flavors, that can be obtained by incubating either milk-fat, cocoa butter, nut and oil triglycerides, and other vegetable triglycerides derived directly from whole milk, butter oil, vegetable oils, nut oils derived from the oils with a lipase (esterase) enzyme. During the incubation period, the enzyme system catalytically releases fatty acids from the triglyceride and results in certain end products. To control the flavor development in the finished product, the system is heated to completely destroy the enzyme activity and to reduce the bacterial counts to very low levels. Drying can be effected by freeze, foam-mat, rotary, tray or spray drying. Spray drying is most preferred. It has been found that the drying step imparts certain benefits to the final product in that certain volatile and undesired flavor notes are eliminated during the drying step. A granulated product formed of a small amount of fat, maltodextrin having a low DE (dextrose equivalent), the DE being less than 5, a flavor component consisting at least of an oil soluble component and preferably also including a water soluble component, and an inert carrier which may be maltodextrin of a higher DE. The product may also include salt, sugar or their equivalents to taste.

ELMT is obtained by incubating either fat or oil derived from the triglyceride of the desired taste with a lipase (esterase) enzyme as described. During the incubation period the enzyme system catalytically releases fatty acids from the triglyceride and results in certain end products. Specific action of the lipase system releases volatile, flavorful, fatty acids including butyric, caproic, caprylic and capric acids in much greater molar concentrations than, but together with, long chain fatty acids. To control the flavor development in the finished product, the system is heated to completely destroy the enzyme activity and to reduce the bacterial counts to very low levels.

The water soluble component consists of distillates from triglycerides derived from nuts, vegetable oils, and dairy products. This product, also known as starter distillate, is the mixture of flavor compounds distilled from the desired triglyceride taste. It contains the flavor compounds that are volatile with water at 212° F. Starter distillate is obtainable commercially as “starter distillate”. The water soluble flavor component is used in the composition of the present invention in an amount of up to 10% by weight of the final product, and preferably in an amount of 0.05-0.5% of the final product on the dry solids basis.

By incorporating therein oil soluble lipolyzed triglycerides (obtained by treating triglycerides with lipase enzymes) and water soluble starter distillate in an amount sufficient to impart the flavor to the chewing gum. The proportion of water soluble component to oil soluble component should be between 1 part water soluble component per each 2-20 parts oil soluble component. It is necessary for the water phase to be distributed throughout the oil phase. This can be accomplished either by mixing the oil and water phases with a carrier such as maltodextrin and drying, which causes the phases to become encapsulated, or by emulsifying the two phases by means of an emulsifying agent.

The above mentioned components are mixed with an inert carrier such as dextrins, whey solids, corn syrup solids and the like. The most preferred inert carrier is maltodextrin, namely maltodextrins with a DE of between 10 and 20. The preferred process for making the ELMT product of the invention consists in first preparing a 50-60% solids emulsion, heating the emulsion to between about 120°-160° F., and passing the emulsion through a homogenizer to form a stable emulsion. This emulsion is then conveyed to a spray tower equipped with pressure nozzles and with the provision for the introduction of an inert gas such as nitrogen or carbon dioxide (preferably carbon dioxide). The emulsion is then sprayed by means of the inert gas at an exit air temperature at the spray tower of preferably about 210° F. and utilizing a carbon dioxide pressure of 15 psig. The resulting dry product has a bulk density of between 20 and 35 g/100 cc and preferably between 22 and 30 g/100 cc. The final ELMT product exhibits the following characteristics:

a) It has the flavor intensity of about 10 g of original triglyceride.

b) It has the natural flavor of triglyceride.

c) It dissolves instantly upon contact with wet and hot foods, thus providing not only the flavor but also the mouthfeel of triglyceride.

d) It has an extended shelf-life and is extremely stable to oxidation.

Lipolized modified oils, fats, and fatty acids of mono-, di-, and tri-glycerides are selected from the group of dairy fats and creams, vegetable oils, nut oils, and other fatty acids of mono-, di-, and tri-glycerides. Preferred fats, oils, and fatty acids of mono-, di-, and tri-glycerides are selected from the group of cocoa butter, nut oils, butter, cheese, milk.

The encapsulant shell is selected based on the preferred release mechanism and the “carrier” of the dry powder. The encapsulant shell can be made water or oil soluble. The release mechanism of the encapsulant is selected from the group of mechanical rupture of the capsule shell, dissolution of the shell, melting of the shell, and diffusion of the shell.

The encapsulating agents utilized to make the encapsulant shell are selected from the group of fats, hydrolyzed fats, ethyl cellulose, hydroxy propyl methylcellulose, starches and modified starches, polymers, waxes, alginate & alginic acid (e.g., sodium alginate), calcium caseinate, calcium polypectate, carboxyl cellulose, carrageenan, cellulose acetate phthalate, cellulose acetate trimellitate, chitosan, corn syrup solids, dextrins, fatty acids, fatty alcohols, gelatin, gellan gums, gum arabic, hydroxy cellulose, hydroxyl ethyl cellulose, hydroxy methyl cellulose, hydroxy propyl cellulose, hydroxy propyl ethyl cellulose, hydroxy propyl methyl cellulose, hydroxy propyl methyl cellulose phthalate, lipids, liposomes, low density polyethylene, mono-, di- and tri-glycerides, pectins, phospholipids, polyethylene glycol, polylactic polymers, polylactic co-glycolic polymers, polyvinyl pyrolindone, shellac, stearic acid and derivatives, gums (e.g., xanthum) and proteins (e.g., zein, gluten).

Standard chewing gum additives are selected from the group of group elastomers; elastomer plasticizers; fillers; softeners; waxes; antioxidants; colorants; emulsifiers; colors; acidulants; texturing agents; and other components that provide desired attributes and adding time release components selected from the group of flavors; flavoring agents; colors; acidulants; minerals, vitamins and bioactive agents.

The present invention does not preclude the direct addition of ELMT to the gum base. The compositions of the present invention are thus processed at a temperature ideally below 80 degree Celsius to prevent premature degradation or volatilazation of the flavorant. Typical gum ingredients can then be blended and mixed with the gum base with little difficulty.

Incorporation of ELMT Flavorant into Chewing Gum Examples

ELMT encapsulated in a capsule shell that will rupture from mechanical pressure is incorporated into the unfinished chewing gum in an amount of 100% of the desired flavor associated with the ELMT.

ELMT encapsulated in a capsule shell that will rupture from mechanical pressure is incorporated into the unfinished chewing gum in an amount of 80% of the desired flavor associated with the ELMT. ELMT encapsulated in a capsule shell that will diffuse through the shell when chewed is incorporated into the unfinished chewing gum in an amount of 20% of the desired flavor associated with the ELMT.

ELMT encapsulated in a capsule shell that will rupture from mechanical pressure is incorporated into the unfinished chewing gum in an amount of 60% of the desired flavor associated with the ELMT. ELMT encapsulated in a capsule shell that will diffuse through the shell when chewed is incorporated into the unfinished chewing gum in an amount of 20% of the desired flavor associated with the ELMT. ELMT not encapsulated is incorporated directly into the unfinished chewing gum in an amount of 20% of the desired flavor associated with the ELMT for an immediate flavor release.

ELMT encapsulated in a capsule shell that will rupture from mechanical pressure is incorporated into the unfinished chewing gum in an amount of 60% of the desired flavor associated with the ELMT. ELMT encapsulated in a capsule shell that will dissolute the shell when chewed is incorporated into the unfinished chewing gum in an amount of 20% of the desired flavor associated with the ELMT. ELMT not encapsulated is incorporated directly into the unfinished chewing gum in an amount of 20% of the desired flavor associated with the ELMT for an immediate flavor release.

In an embodiment, the chewing gum flavors in a wide range of flavors are now possible. The flavor range includes individual flavors and combinations of flavors.

In an embodiment, the chewing gum flavor is chocolate. Such flavor is comprised of ELMT cocoa butter and chocolate solids.

In an embodiment, the chewing gum flavor is milk chocolate. Such flavor is comprised of ELMT cocoa butter, chocolate solids, and dry milk powder.

In an embodiment, the chewing gum flavor is chocolate mint. Such flavor is comprised of ELMT cocoa butter, chocolate solids, and mint.

In an embodiment, the chewing gum flavor is beer. Such flavor is comprised of ELMT cocoa butter, and dry beer solids.

In an embodiment, the chewing gum flavor is nacho. Such flavor is comprised of ELMT cheese, dry solid spices (e.g., jalapeno pepper, yeast, etc.) and dry beer solids.

In an embodiment, the chewing gum flavor is butter popcorn. Such flavor is comprised of ELMT butter, ELMT corn oil, dry solid spices and dry beer solids.

In an embodiment, the chewing gum flavor is peanut butter and jelly. Such flavor is comprised of ELMT peanut, dry solid spices, and dry solid grape concentrates.

In an embodiment, the chewing gum flavor is complimented with other flavors. Such flavors are comprised of coffee and vanilla.

If desired, the chewing gum can also include cellulose fiber in an amount of up to 3% of the water content, the cellulose fibers having a particle size preferably in the range of not greater than 400 microns, and more preferably in the range of 50-200 microns. A particle size of more than 400 microns gives the gum a texture that is too gritty or stringy. The amount of cellulose fiber depends to a large extent on the amount of water in the gum. Gums having about 15% of water require no cellulose fibers or at most a very small amount, while gums having a high water content of up to 60% require higher cellulose fiber content in a range of about 0.05-3% of the water content. If less than 0.05% cellulose fiber is used in such gums, the amount of fiber is not sufficient to provide the desired texture for good chewability. On the other hand, an amount of more than 3% makes the product too stiff and therefore loses chewability. The higher percentage is used for higher water contents. When used at the preferred levels, the cellulose fibers serve as non-caloric moisture binders and improve the texture and mouthfeel of the gums. The cellulose fibers also improve the flavor impact in spreads having a high water content. In accordance with a preferred embodiment of the present invention, the water soluble starter distillate and oil soluble lipolyzed oils are both spray dried and in this dry form mixed with the aqueous phase from which the water-in oil emulsion of the chewing gum is made.

The flavor must be homogeneously distributed within the emulsion and yet must be available to the taste buds during consumption. Still further, the flavor must also be stable upon storage of this chewing gum for periods of up to six months and must be stable upon heating and during processing. The resulting flavor base becomes shelf stable and does not change upon storage and still further the flavor base can be more easily incorporated into the chewing gum since it can be mixed into the water phase of the gum base and thoroughly emulsified therewith before being added to the fat phase.

The water phase can also be distributed through the oil phase by emulsification with any of the common commercial emulsifying agents such as lecithin, to form a paste which paste can also be used for the purposes of the present invention.

It is accordingly a secondary object of the present invention to provide chewing gum with natural flavors derived traditionally from ELMT triglycerides that are further solubilized by the inclusion of a fruit concentrate sweetener composition. The fruit concentrate sweetener composition comprises a blend of a hydrolyzed starch having a dextrose equivalent (D.E.) of up to 25 and a fruit juice or fruit syrup concentrate of at least about 40% soluble solids and about 0% insoluble solids thereby forming a liquor having a dry weight composition of about 40 to 65% complex carbohydrates, about 35 to 55% simple sugars from the fruit juice or fruit syrup concentrate and about 0 to 5% nutritional components occurring naturally in the fruit juice or fruit syrup concentrate. The sweetener composition is preferably dried to about 78 to 80% soluble solids to make the sweetener composition suitable for replacing corn syrup and the like or to dry the product to about 96 to 99% soluble solids to make the sweetener composition suitable for replacing powdered or granulated sucrose and like sweeteners. The amount of low DE maltodextrin is preferably between about 1-10% by weight, the DE thereof being preferably less than 5. Most preferably this maltodextrin is derived from potato.

A composition and method for supplementing a water soluble gum portion and a water insoluble gum base portion including a enzymatically modified fats, oils, and generally triglycerides in chewing gum systems The composition is selected from the group of (A) an enzymatically modified fatty acids of mono-, di-, and tri-glycerides with, (B) an encapsulating agent, (C) fruit concentrate sweetener composition, and (D) standard chewing gum additives. The composition provides an effective increase in new flavor profiles, superior mouthfeel, acceptance, nutritional, therapeutic, and pharmacological properties in food, nutrition and diet systems through chewing gum.

Typical chewing gum ingredients include: elastomers; elastomer plasticizers; fillers; softeners; waxes; antioxidants; colorants; flavors; and bulk sweeteners; high intensity sweeteners; flavoring agents; softeners; emulsifiers; colors; acidulants; fillers; and other components that provide desired attributes. Chewing gum generally consists of a water insoluble gum base, a water soluble portion, and flavors. Traditionally, the water soluble portion dissipates with a portion of the flavor over a period of time during chewing. An alternative method is to encapsulate a portion of the flavor with an encapsulant for timed release of the flavor. The gum base portion is retained in the mouth throughout the chew. The insoluble gum base generally comprises elastomers, resins, fats and oils, softeners, and inorganic fillers.

Accordingly, a chewing gum composition is provided that comprises a water soluble gum portion and a water insoluble gum base portion including an enzymatically modified triglyceride or lipolyzed modified triglyceride (“ELMT”) that may dissolve or may be water insoluble. In an embodiment, the gum comprises ELMT from approximately 1 percent to about 10 percent by weight of chewing gum.

The resultant chewing gum of the present invention will deliver more intense flavors, new flavorants derived from natural ingredients without severely affecting the texture as compared to typical chewing gum compositions.

The present invention also provides a method for creating acceptable chewing gum comprising the steps of: creating a chewing gum base with flavorants derived from fats, oils, creams, and triglycerides to create a resultant chewing gum that avoids the extreme emulsifier affect typical of fats and oils in a chewing gum without ELMT; and adding to the chewing gum base a water soluble portion to create a resultant chewing gum. There are two essential components in the preferred embodiment of the graft copolymers of monomeric and polymeric polyhydroxy compounds gum base (hereinafter referred to as “GCPH”), disclosed in this invention, onto a polyhydroxy “backbone” to develop elastomeric materials.

Graft copolymers of monomeric and polymeric polyhydroxy compounds gum base are provided with a high degree of grafting that enhance the elastomeric behavior of polyhydroxy copolymer delivery systems.

The term grafted copolymer of polyhydroxy compounds is used interchangeably with the above definition and is hereafter referred to as “GCPH” or “GCPH copolymers”. The preferred composition is influenced by a number of factors, including cost effectiveness, biodegradability, its' ability to mimic and emulate the characteristics within traditional elastomeric applications (e.g., traditional chewing gum bases, edible film coatings, etc.), elasticity, and compatibility with other components in the copolymer delivery systems.

Polyhydroxy Compounds

Polyhydroxy compounds are selected from the group of monomeric polyhydroxy and polymeric polyhydroxy compounds. Preferred monomeric polyhydroxy compounds are further selected from the group of R—(OH)ₙ wherein R is a branched or straight chain alkyl substituent having between 3 and 12 carbon atoms. One such monomeric polyhydroxy compound is dipentaerythritol, hereinafter referred to as (“DPE”). In accordance with a more preferred embodiment of the invention, preferred compounds include blends of polyhydroxy compounds. One particularly preferred blend comprises 25% of the reactive hydroxyl groups being contributed by DPE and the remaining 75% of the free hydroxyl groups being contributed from PVOH. This blend has demonstrated very good elastomeric properties for a chewing gum base. Preferred polymeric polyhydroxy compounds are preferably selected from the group consisting of polyvinyl alcohol, partially saponified polyvinyl acetates and partially hydrolyzed polyvinyl ethers, polyglycerol. Polyglycerols are preferably selected from the group consisting of diglycerol, triglycerol, monoisopropylidene diglycerol, and monoisopropylidene triglycerol. Particularly preferred polyhydroxy copolymers are selected from the group of hydroxy compounds acceptable as food ingredients. More particularly preferred polyhydroxy compound is polyvinyl alcohol (CH₂—CH—OH)ₙ, hereinafter referred to as “PVOH”. PVOH, one such exemplary is ELVANOL® of duPont starts with polyvinyl acetate (CH2—CH—O—CO)—CH₃), hereafter referred to as “PVOAc”, and subjects it to acid hydrolysis. The reaction formula is

R—O—CO—CH₃+H+→R—OH+CH₃—COOH

Grafting Segments

Grafting segments are selected from the group α-hydroxyalkanoic acids, β-hydroxyalkanoic acids, and other poly(esters). One such α-hydroxyalkanoic acid exemplary is lactic acid “LA”, where R is CH₃ in the formula R—CH(OH)—COOH. Another such α-hydroxyalkanoic acid exemplary is glycolic acid (“GA)”, where R is H. When R is CH₃ the α carbon is asymmetric, thus the forms of lactic acid are selected from the group of L(+) or D(−) configurations. Exemplary biodegradable homopolymers are selected from the group consisting of polylactides, polyglycolides, poly(p-dioxanones), polycaprolactones, polyhydroxyalkanoates, polypropylenefumarates, polypeptides, and genetically engineered polymers. Preferred biodegradable homopolymers are selected from the group of polylactides, polyglycolides, poly(p-dioxanones), polycaprolactones, and polyhydroxyalkanoates. Exemplary copolymers are selected from the group of poly(lactide-glycolides), poly(p-dioxanone-lactides), poly(p-dioxanone-glycolides), poly(p-dioxanonelactide-glycolides), poly(p-dioxanone-caprolactones), poly(p-dioxanone-alkylene carbonates), poly(p-dioxanone-alkylene oxides), poly(p-dioxanone-carbonate-glycolides), poly(p-dioxanone-carbonates), poly(caprolactone-lactides), poly(caprolactone-glycolides), poly(hydroxyalkanoates), poly(ester-amides), poly(ester-urethanes), polypeptides and genetically engineered copolymers.

The principle of manufacturing GCPH copolymers is practiced with the grafting and esterification of components selected from the group of polyhydroxy compounds, grafting segments, co-reactants, crosslinking agents, transesterification catalaysts, monofunctional fatty acid terminators, flavorants and colorants, and combined in proportions all by weight of the copolymer ingredients.

A composition and method for supplementing a water soluble gum portion and a water insoluble gum base portion including a enzymatically modified fats, oils, and generally triglycerides in chewing gum systems. The composition is selected from the group of (A) an enzymatically modified triglyceride with, (B) an encapsulating agent, (C) naturally flavored with dairy fats and creams, vegetable oils, nut oils and other triglycerides, (D) graft copolymers of monomeric and polymeric polyhydroxy compounds gum base, and (E) standard chewing gum additives. The composition provides an effective increase in new flavor profiles, superior mouthfeel, acceptance, nutritional, therapeutic, and pharmacological properties in food, nutrition and diet systems through chewing gum.

Gum Base

The present invention provides copolymers with improved elastomeric behavior compounded with components selected from the group of enzymatically modified fats, oils and triglycerides, an encapsulating agent, and naturally flavored with dairy fats and creams, vegetable oils, nut oils and other triglycerides, methods for making same, and methods for making said copolymer into a chewing gum base. The additional method of use as a component in a chewing gum base and its' preferred embodiments of the invention will now be set forth.

GCPH based polymers may be added to a gum base or, more preferably, used in gum in place of a typical gum base providing an enhanced flavor delivery vehicle. It is therefore an object of the invention to be an elastomeric material in chewing gum bases, and further resulting chewing gum compositions. It is therefore an object of the invention to utilize GCPH copolymers as an essential component within chewing gum base with components selected from the group of enzymatically modified fats, oils and triglycerides, an encapsulating agent, and naturally flavored with dairy fats and creams, vegetable oils, nut oils and other triglycerides. The present invention does not further preclude the addition of ingredients known in the art of manufacturing chewing gum base formulations and may modify the GCPH copolymer to provide desirable characteristics. The addition of ingredients known in the art of manufacturing chewing gum base formulations are selected from the group of elastomers; elastomer plasticizers; fillers; softeners; waxes; antioxidants; colorants; emulsifiers; acidulants; resins, fats and oils; and other components to provide the desired gum base attributes. The term gum base, as used in the context of the present invention is the elastomeric material that serves as the masticatory substance that historically is insoluble in salvinary fluids and is retained in the mouth throughout the chewing experience.

The present invention does not yet further preclude a chewing gum base composition that incorporates encapsulates of flavor and colorant agents as a means to enhance the consumer appeal due to unique flavor and colorant release characteristics as compared to typical compositions derived. Typical gum flavors and coloring are quickly dissipated during the process of chewing. It is therefore an object of the invention for a chewing gum base to release flavors and/or colorant agents over the duration of the chewing experience. The process includes the controlled flavor and active release over an extended duration for either longer lasting flavors and actives or the lower level of expensive flavors and actives.

The present invention does not yet further preclude a chewing gum base composition that incorporates the graft copolymers of polyhydroxy compounds with components selected from the group of enzymatically modified fats, oils and triglycerides, an encapsulating agent, and naturally flavored with dairy fats and creams, vegetable oils, nut oils and other triglycerides utilizing standard principles of making active release chewing gums bases. As used herein the term “active release” refers to a gum base that provide a controlled release of flavor, pharmaceutical, or nutraceutical actives. The process includes the controlled actives release over an extended duration for sustained delivery of intended actives results.

An advantage of GCPH based copolymers is that they are compatible with naturally flavored with dairy fats and creams, vegetable oils, nut oils and other fatty acids of mono-, di, and tri-glycerides. A further advantage of GCPH based copolymers is that they are also compatible with that enzymatically modified oils, fats, and fatty acids of mono-, di-, and tri-glycerides, and lipolyzed modified oils, fats, and fatty acids of mono-, di-, and tri-glycerides. Thus, the GCPH copolymers have a wide variety of application. It is therefore an object of the present invention for the graft copolymers of polyhydroxy compounds to be further prepared into chewing gum bases utilizing standard principles of making flavored chewing gums. As used herein the term “compatible” refers to a gum that will not experience the extreme emulsifier affect typical of fats and oils in a chewing gum.

The principle of manufacturing these gum bases derived from GCPH copolymers with components selected from the group of enzymatically modified fats, oils and fatty acids of mono-, di-, and tri-glycerides, an encapsulating agent, and naturally flavored with dairy fats and creams, vegetable oils, nut oils and other fatty acids of mono-, di-, and tri-glycerides is known in the art with additional gum base components selected from the group of elastomers, fillers, softeners, fats, emulsifiers, elastomer plasticizers, texturing agents, waxes, acidulants, flavorants and colorants, antioxidants, and other agents to impart exemplary properties such as organoleptic, processing, nutritional, and medicinal combined in proportions all by weight of the gum base ingredients typically selected from the group of:

The gum base is then further compounded with ingredients selected from the group of fats, oils, flavorants, pharmaceutical actives, nutraceutical actives, and nutrients; preferred fats, oils, flavorants, pharmaceutical actives, nutraceutical actives, and nutrients are further encapsulated to achieve the purpose selected from the group of time release, mask off-flavors, protect from premature breakdown in mouth, digestive tract, and stomach;

Chewing Gum

The principle of manufacturing chewing gums; whereas chewing gum as used in the context of the present invention, also includes bubble gum; whereas the gum consists of two major components: 1) the chewing gum base and 2) a non-masticatory part, consisting mainly of sweeteners, softeners and flavor ingredients; and whereas the chewing gum is derived from GCPH copolymer gum bases with components selected from the group of enzymatically modified fats, oils and triglycerides, an encapsulating agent, and naturally flavored with dairy fats and creams, vegetable oils, nut oils and other fatty acids of mono-, di-, and tri-glycerides known in the art with additional gum components typically selected from the group of:

The gum mass comprises one or more components selected from the group of flavors, bulk sweeteners, high intensity sweeteners, low caloric bulking agents and combinations thereof, preferred bulk sweeteners are selected from the group of sugar sweeteners, sugarless sweeteners, and combinations thereof; preferred high intensity sweeteners are selected from the group of artificial sweeteners, natural intense sweeteners, and peptide sweeteners; more preferred high intensity artificial sweeteners are subjected to encapsulation by such techniques selected from the group of wet granulation, wax granulation, spray drying, spray chilling, fluid bed coating, coacervation, fiber extension, micro-encapsulation, cyclodextrin “encapsulation”; where as exemplary sugar sweeteners are saccharides (e.g., sucrose, dextrose, maltose, dextrin, dried invert sugar, fructose, levulose, galactose, corn syrup solids); whereas exemplary sugarless sweeteners are sugar alcohols (e.g., erythritol, sorbitol, mannitol, xylitol, hydrogenated starch hydrolysates, maltitol), whereas exemplary high intensity artificial sweeteners are sucralose, aspartame, salts of acesulfame, alitame, thaumatin, saccharin and its salts, cyclamic acid and its salts, glycyrrhizin, dihydrochalcones, thaumatin, monellin, and where as exemplary low caloric bulking agents are: polydextrose; oligofructose; fructooligosaccharide; palatinose oligosaccharide; natural carbohydrate gum hydrolysate; or indigestible dextrins;

The gum mass comprises one or more flavorants and colorants for exemplary purposes that impart specific flavor profiles, and removing or masking undesired characteristics; exemplary flavorants are cocoa powder; heat-modified amino acids; partially defatted proteins, vegetable extracts, natural extracts (e.g., citrus oils, fruit essences, peppermint oil, spearmint oil, clove oil, oil of wintergreen, anise), artificial flavorants and combinations thereof; exemplary colorants are FD&C type lakes, plant extracts, fruit and vegetable extracts and titanium dioxide and combinations thereof; preferred flavorants and colorants levels are present from about 0% to 15% by weight, and are more fully and evenly released by the gum base of the present invention;

The gum mass comprises one or more components selected from the group of pharmaceutical actives, nutraceutical actives, minerals, and vitamins;

The gum mass comprises one or more components selected from the group of encapsulated pharmaceutical actives, nutraceutical actives, minerals, and vitamins to make an actives release chewing gum, whereas term “active release” refers to a gum that provides a controlled release of flavor, pharmaceutical, or nutraceutical actives;

The base includes acidulants as flavor and flavor enhancers selected from the group of edible acids; the preferred acids include acetic, citric, lactic, and ascorbic acid;

Additional features and advantages of the present invention are described in and will be apparent from the detailed description of the presently preferred embodiments. It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

### EXAMPLES

### Example 1

Nineteen (19) grams of gum base was added to a small gum mixer set at 50 degree C. for a duration of 20 minutes in addition to 60 grams of 6×sugar and 20 grams of 45Be corn syrup. 2 grams of ELMT cocoa butter, 0.5 g of 99% glycerol and 0.6 grams of mint flavor are subsequently added and mixed for 5 additional minutes.

### Example 2

Nineteen (19) grams of gum base was added to a small gum mixer set at 50 degree C. for a duration of 20 minutes in addition to 60 grams of 6×sugar and 20 grams of 45Be corn syrup. 2 grams of ELMT cocoa butter that is encapsulated in a capsule shell that will rupture from mechanical pressure, 0.5 g of 99% glycerol and 0.6 grams of mint flavor are subsequently added and mixed for 5 additional minutes.

### Example 3

Nineteen (19) grams of gum base was added to a small gum mixer set at 50 degree C. for a duration of 20 minutes in addition to 60 grams of 6×sugar and 20 grams of 45Be corn syrup. 1.5 grams of ELMT cocoa butter that is encapsulated in a capsule shell that will rupture from mechanical pressure, 0.5 g of ELMT cocoa butter that is encapsulated in a capsule shell that will diffuse through the shell when chewed, 0.5 g of 99% glycerol and 0.6 grams of mint flavor are subsequently added and mixed for 5 additional minutes.

### Example 4

Nineteen (19) grams of gum base was added to a small gum mixer set at 50 degree C. for a duration of 20 minutes in addition to 60 grams of 6×sugar and 20 grams of 45Be corn syrup. 1.5 grams of ELMT cocoa butter that is encapsulated in a capsule shell that will rupture from mechanical pressure, 0.5 g of ELMT cocoa butter that is encapsulated in a capsule shell that will diffuse through the shell when chewed, 1.5 grams of ELMT cocoa butter that is not encapsulated, 0.5 g of 99% glycerol and 0.6 grams of mint flavor are subsequently added and mixed for 5 additional minutes.

### Example 5

Nineteen (19) grams of gum base was added to a small gum mixer set at 50 degree C. for a duration of 20 minutes in addition to 60 grams of 6×sugar and 20 grams of 45Be corn syrup. 2 grams of ELMT cocoa butter, 2 grams of chocolate solids, 0.5 g of 99% glycerol and 0.2 grams of mint flavor are subsequently added and mixed for 5 additional minutes.

### Example 6

Nineteen (19) grams of gum base was added to a small gum mixer set at 50 degree C. for a duration of 20 minutes in addition to 60 grams of 6×sugar and 20 grams of 45Be corn syrup. 2 grams of ELMT cocoa butter, 2 grams of chocolate solids, 2 grams of dry milk powder, 0.5 g of 99% glycerol and 0.2 grams of mint flavor are subsequently added and mixed for 5 additional minutes.

### Example 7

Nineteen (19) grams of gum base was added to a small gum mixer set at 50 degree C. for a duration of 20 minutes in addition to 60 grams of 6×sugar and 20 grams of 45Be corn syrup. 2 grams of ELMT cocoa butter, 2 grams of dry beer solids, and 0.5 g of 99% glycerol are subsequently added and mixed for 5 additional minutes.

### Example 8

Nineteen (19) grams of gum base was added to a small gum mixer set at 50 degree C. for a duration of 20 minutes in addition to 60 grams of 6×sugar and 20 grams of 45Be corn syrup. 2 grams of ELMT cheese, 2 grams of dry beer solids, and 0.5 g of 99% glycerol are subsequently added and mixed for 5 additional minutes.

### Example 9

Nineteen (19) grams of gum base was added to a small gum mixer set at 50 degree C. for a duration of 20 minutes in addition to 60 grams of 6×sugar and 20 grams of 45Be corn syrup. 2 grams of ELMT butter, 2 grams of ELMT corn oil, and 0.5 g of 99% glycerol are subsequently added and mixed for 5 additional minutes.

### Example 10

Nineteen (19) grams of gum base was added to a small gum mixer set at 50 degree C. for a duration of 20 minutes in addition to 60 grams of 6×sugar and 20 grams of 45Be corn syrup. 2 grams of ELMT peanut oil, 2 grams of ELMT cocoa butter, 2 grams of dry grape solids and 0.5 g of 99% glycerol are subsequently added and mixed for 5 additional minutes.

### Example 11

Nineteen (19) grams of gum base was added to a small gum mixer set at 50 degree C. for a duration of 20 minutes in addition to 60 grams of 6×sugar and 20 grams of 45Be corn syrup. 1.5 grams of ELMT cocoa butter that is encapsulated in a capsule shell that will rupture from mechanical pressure, 0.5 g of ELMT cocoa butter that is encapsulated in a capsule shell that will diffuse through the shell when chewed, 0.5 g of 99% glycerol and 0.6 grams of vanilla flavor are subsequently added and mixed for 5 additional minutes.

### Example 12

Nineteen (19) grams of gum base was added to a small gum mixer set at 50 degree C. for a duration of 20 minutes in addition to 60 grams of 6×sugar and 20 grams of 45Be corn syrup. 1.5 grams of ELMT cocoa butter that is encapsulated in a capsule shell that will rupture from mechanical pressure, 0.5 g of ELMT cocoa butter that is encapsulated in a capsule shell that will diffuse through the shell when chewed, 0.5 g of 99% glycerol and 0.6 grams of coffee flavor are subsequently added and mixed for 5 additional minutes.

### Example 13

Nineteen (19) grams of gum base was added to a small gum mixer set at 50 degree C. for a duration of 20 minutes in addition to 60 grams of 6×sugar and 20 grams of fruit sweetener composition. 2 grams of ELMT cocoa butter that is encapsulated in a capsule shell that will rupture from mechanical pressure, 0.5 g of 99% glycerol and 0.6 grams of mint flavor are subsequently added and mixed for 5 additional minutes. The fruit concentrate sweetener composition comprises a blend of a hydrolyzed starch having a dextrose equivalent (D.E.) of 25 and a fruit juice or fruit syrup concentrate of 40% soluble solids and 2% insoluble solids thereby having a dry weight composition of 50 complex carbohydrates, about 40% simple sugars from the fruit juice or fruit syrup concentrate and about 3% nutritional components occurring naturally in the fruit juice or fruit syrup concentrate. The sweetener composition was dried to to 80% soluble solids to make the sweetener composition suitable for replacing corn syrup.

While the foregoing examples are illustrative of various embodiments of the invention, those of ordinary skill in the art will understand and appreciate that such examples are non-limiting and that variations in for example, grafted segments, weight percentages, relative percentages, complementary chewing gum base ingredients, complementary chewing gum ingredients, manufacturing processes and conditions are contemplated and included within the scope of the present invention which is limited only by the claims appended hereto.

What is claimed is:

1. A chewing gum composition having new flavor profiles and increased intensity of existing flavor profiles which comprises:
(A) enzymatically modified oils, fats, and fatty acids of mono-, di-, and tri-glycerides;
(B) lipolyzed modified oils, fats, and fatty acids of mono-, di-, and tri-glycerides;
(C) encapsulating agent; and
(D) standard chewing gum additives;

2. The chewing gum composition according to claim 1, wherein the enzymatically modified oils, fats, and fatty acids of mono-, di-, and tri-glycerides, and lipolyzed modified oils, fats, and fatty acids of mono-, di-, and tri-glycerides is present in an amount up to 10%, by weight of the chewing gum composition.

3. The chewing gum composition according to claim 1, wherein the enzymatically modified oils, fats, and fatty acids of mono-, di-, and tri-glycerides, and lipolyzed modified oils, fats, and fatty acids of mono-, di-, and tri-glycerides is selected from the group of dairy fats and creams, vegetable oils, nut oils and other triglycerides.

4. The composition according to claim 3, wherein the dairy fats and creams, vegetable oils, nut oils and other fatty acids of mono-, di-, and tri-glycerides are selected from the group of cocoa butter, nut oils, butter, cheese, milk, natural oils from spices, and fruits.

5. The composition according to claim 4, wherein the nut oils and meats are selected from the group of peanut, almond, pistachio, hazelnut, cashew, walnut, hemp seed and macadamia.

6. The chewing gum composition according to claim 1, wherein the enzymatically modified oils, fats, and fatty acids of mono-, di-, and tri-glycerides, and lipolyzed modified oils, fats, and fatty acids of mono-, di-, and tri-glycerides are combined with additional ingredients prior to encapsulation selected from the group of dry milk powder, dry beer solids, dry solid spices, food ingredients, sweeteners, emulsifiers, softeners, colorants, nutraceutical actives, pharmaceutical actives and antioxidants.

7. The chewing gum composition according to claim 1, wherein the enzymatically modified oils, fats, and fatty acids of mono-, di-, and tri-glycerides, and lipolyzed modified oils, fats, and fatty acids of mono-, di-, and tri-glycerides further comprising active release agents that permit a controlled release of flavor, pharmaceutical, or nutraceutical actives.

8. The chewing gum composition according to claim 1, wherein the enzymatically modified oils, fats, and fatty acids of mono-, di-, and tri-glycerides, and lipolyzed modified oils, fats, and fatty acids of mono-, di-, and tri-glycerides are encapsulated with encapsulant shell to achieve time release of the flavor.

9. The chewing gum composition according to claim 1, wherein the encapsulant shell is selected from the group of water and oil soluble ingredients.

10. The chewing gum composition according to claim 1, wherein the encapsulant shell is selected to achieve a release mechanism of the encapsulant from the group of mechanical rupture of the capsule shell, dissolution of the shell, melting of the shell, and diffusion of the shell.

11. The chewing gum composition according to claim 1, wherein the composition further comprises fruit concentrate sweetener composition to further solubilize the enzymatically modified oils, fats, and fatty acids of mono-, di-, and tri-glycerides, and lipolyzed modified oils, fats, and fatty acids of mono-, di-, and tri-glycerides.

12. The chewing gum composition according to claim 11, wherein the fruit concentrate sweetener composition comprises a blend of:
(A) hydrolyzed starch having a dextrose equivalent (D.E.) of up to 25;
(B) fruit juice or fruit syrup concentrate of at least 40% soluble solids and 0% insoluble solids thereby forming a liquor having a dry weight composition of 40 to 65% complex carbohydrates;
(C) 35 to 55% simple sugars from the fruit juice or fruit syrup concentrate; and
(D) 0 to 5% nutritional components occurring naturally in the fruit juice or fruit syrup concentrate.

13. The chewing gum composition according to claim 12, wherein the fruit concentrate sweetener composition is further processed with steps selected from the group:
(A) dried to 78 to 80% soluble solids to make the sweetener composition suitable for replacing corn; and
(B) dried to 96 to 99% soluble solids to make the sweetener composition suitable for replacing powdered or granulated sucrose.

14. The chewing gum composition according to claim 1, wherein the composition further comprises a chewing gum base of grafted polyhydroxy copolymers.

15. The chewing gum composition according to claim 14, wherein the composition further comprises standard unmodified oils, fats, and fatty acids of mono-, di-, and tri-glycerides up to 15% on a total weight basis chewing gum composition.

16. The composition according to claim 14, where the grafted polyhydroxy copolymers are selected from the group consisting of polyhydroxy-substituted monomers, polyhydroxy-substituted polymers, and blends thereof.

17. The composition according to claim 14, further comprising grafting segments selected from the group of α-hydroxyalkanoic acids, β-hydroxyalkanoic acids and polyesters.

18. The composition according to claim 14, further comprising at least one gum base component selected from the group consisting of elastomers, plasticizers, fillers, softeners, waxes, antioxidants, colorants, emulsifiers, acidulates, texturing agents, flavoring agents, sweeteners, vitamins, minerals and bioactive agents.

19. The composition according to claim 16 wherein the polyhydroxy copolymers are selected from the group of copolymers consisting polylactide-glycolides, poly(p-dioxanone) lactides, poly(p-dioxanone) glycolides), poly(p-dioxanone) lactide-glycolides, poly(p-dioxanone) caprolactones, poly(p-dioxanone)alkylene carbonates, poly(p-dioxanone) alkylene oxides, poly(p-dioxanone) carbonate-glycolides, poly(p-dioxanone) carbonates, polycaprolactone lactides, polycaprolactone glycolides, polyhydroxyalkanoates, polyester amides, polyester urethanes, and polypeptides.
